(19) United States
(12) Patent Application Publication
(10) Pub. No.: US 2025/0117892 A1
(43) Pub. Date: Apr. 10, 2025

(54) TEMPORALLY CORRELATED NOISE WARPING FOR DIFFUSION MODELS

(71) Applicants: DISNEY ENTERPRISES, INC., Burbank, CA (US); ETH Zürich (Eidgenössische Technische Hochschule Zürich), Zürich (CH)

(72) Inventors: Vinicius DA COSTA DE AZEVEDO, Zürich (CH); Chien-Hsi Pascal Clement CHANG, Zürich (CH); Jingwei TANG, Zürich (CH)

(21) Appl. No.: 18/900,554

(22) Filed: Sep. 27, 2024

Related U.S. Application Data
(60) Provisional application No. 63/563,194, filed on Mar. 8, 2024.
(60) Provisional application No. 63/586,375, filed on Sep. 28, 2023.

(51) Int. Cl. G06T 5/60; G06T 3/18; G06T 3/40; G06T 5/70; G06T 7/246

(52) U.S. Cl. CPC G06T 5/60; G06T 3/18; G06T 3/40; G06T 5/70; G06T 7/248; G06T 2207/10016; G06T 2207/20084

(57) ABSTRACT

One embodiment of the present invention sets forth a technique for generating data. The technique includes determining a first set of flow vectors between a first input frame and a second input frame. The technique also includes generating, based on the first set of flow vectors and a first noise sample associated with the first input frame, a second noise sample associated with the second frame. The technique further includes converting, via execution of a diffusion model, the first input frame into a first output frame based on the first noise sample and converting, via execution of the diffusion model, the second input frame into a second output frame based on the second noise sample.

### CROSS-REFERENCE TO RELATED APPLICATIONS

This application claims the priority benefit of the U.S. Provisional Application titled “CONSISTENT GUIDING OF DIFFUSION MODELS THROUGH A UNIFIED NOISE MODEL,” filed on Mar. 8, 2024, and having Ser. No. 63/563,194 and also claims the priority benefit of the U.S. Provisional Application titled “TEMPORALLY COHERENT NOISE PRIOR FOR DIFFUSION MODELS,” filed on Sep. 28, 2023, and having Ser. No. 63/586,375. The subject matter of these related applications is hereby incorporated herein by reference.

### BACKGROUND

### Field of the Various Embodiments

Embodiments of the present disclosure relate generally to machine learning and generative models and, more specifically, to temporally correlated noise warping for diffusion models.

### Description of the Related Art

Generative models refer to deep neural networks and/or other types of machine learning models that are trained to generate new instances of data and/or augment existing data. For example, a generative model may be trained on a training dataset of images of cats. During the training process, the generative model “learns” the visual attributes of various cats depicted in the images. These learned visual attributes may then be used by the generative model to produce new images of cats that are not found in the training dataset. In another example, a generative model may be used to perform denoising, sharpening, blurring, colorization, compositing, super-resolution, inpainting, outpainting, and/or other types of image editing that involves altering the appearance, structure, and/or content of an image.

A diffusion model is one type of generative model. A diffusion model typically includes a forward diffusion process that gradually perturbs input data (e.g., an image) into noise that follows a certain noise distribution over a series of time steps. The diffusion model also includes a reverse denoising process that generates new data by iteratively converting random noise from the noise distribution into the new data over an additional series of time steps. The reverse denoising process is performed by reversing the forward diffusion process and is typically learned by a neural network. For example, the forward diffusion process may gradually add noise to an image of a cat until an image of Gaussian noise is produced. The reverse denoising process may gradually remove noise from an image of Gaussian noise until an image of a cat is produced.

The operation of a diffusion model is frequently conditioned on additional input. For example, a diffusion model may denoise a noise sample by predicting a noise component that is conditioned upon a text prompt and/or image and a time step in the denoising process. In another example, when the diffusion model is used to perform image editing, a reference image to be edited may be inverted into a corresponding noise sample. The inverted noise may then be combined with the text prompt during the denoising process to generate an edited image.

However, noise sampling techniques used in conventional diffusion models can negatively impact the use of the diffusion models in generating and/or editing video and/or other data that includes spatio-temporal correspondences. More specifically, a conventional diffusion model may be used to perform video editing by associating each input frame of a video with a different noise sample (e.g., by inverting the frame, independently sampling each noise sample from a noise distribution, etc.) and generating a corresponding output frame by denoising the noise sample conditioned on a text prompt and/or the corresponding input frame. However, the independently sampled and/or generated noise samples are unable to reflect motion and/or other temporal correlations across the input frames. As a result, output frames generated by denoising the noise samples may include undesirable flickering artifacts across the output frames.

To avoid flickering artifacts in output frames that are generated by denoising independent noise samples for temporally correlated input frames, the same noise sample can be used by a diffusion model to generate and/or edit all frames of a video. However, this approach can result in unnatural “texture sticking” artifacts that appear in the same locations within the outputted frames.

As the foregoing illustrates, what is needed in the art are more effective techniques for generating and/or editing video and/or other spatio-temporally correlated data using diffusion models.

### SUMMARY

One embodiment of the present invention sets forth a technique for generating data. The technique includes determining a first set of flow vectors between a first input frame and a second input frame. The technique also includes generating, based on the first set of flow vectors and a first noise sample associated with the first input frame, a second noise sample associated with the second input frame. The technique further includes converting, via execution of a diffusion model, the first input frame into a first output frame based on the first noise sample and converting, via execution of the diffusion model, the second input frame into a second output frame based on the second noise sample.

One technical advantage of the disclosed techniques relative to the prior art is the ability to generate a noise sample for an input frame that reflects spatio-temporal relationships between the input frame and one or more reference frames. Accordingly, diffusion output that is generated from the noise sample may include fewer artifacts and/or better spatio-temporal consistency than diffusion output that is generated using conventional noise sampling techniques. Another technical advantage of the disclosed techniques is the ability to project images and/or noise from multiple target spaces onto a common canonical space during diffusion-based generation. Consequently, the disclosed techniques can be used with diffusion models to generate visual anagrams with arbitrary rotations and/or transformations, computational optical illusions, infinite zoom videos, image panoramas, and/or other types of complex visual output. These technical advantages provide one or more technological improvements over prior art approaches.

### BRIEF DESCRIPTION OF THE DRAWINGS

The patent application or application file contains at least one drawing executed in color. Copies of this patent or patent application publication with color drawings will be provided by the Office upon request and payment of the necessary fee.

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of the warping engine and generation engine of FIG. 1, according to various embodiments.

FIG. 3A illustrates how the sampling component of FIG. 2 generates upsampled noise values from reference noise values included in a reference noise sample, according to various embodiments.

FIG. 3B illustrates how the noise transport component of FIG. 2 performs noise warping using the integral noise representation of FIG. 3A, according to various embodiments.

FIG. 4 is a flow diagram of method steps for generating a sequence of output frames, according to various embodiments.

FIG. 5A illustrates how the flow vectors of FIG. 2 are used to warp between a set of reference locations in a canonical space and multiple sets of target locations in multiple corresponding target spaces, according to various embodiments.

FIG. 5B illustrates how the generation engine of FIG. 1 performs a denoising step that maintains mutual consistency across multiple views associated with a canonical space, according to various embodiments.

FIG. 6 is a flow diagram of method steps for generating output in a canonical space that incorporates views from different target spaces, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

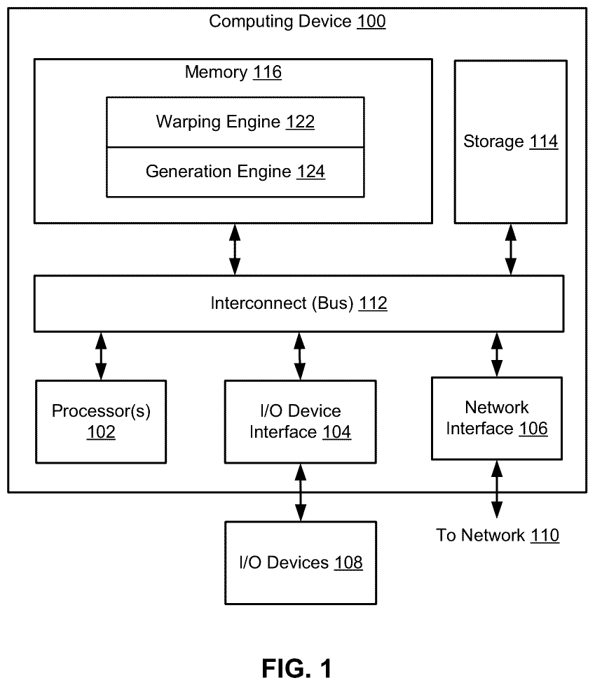

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a warping engine 122 and a generation engine 124 that reside in memory 116.

It is noted that the computing device described herein is illustrative and that any other technically feasible configurations fall within the scope of the present disclosure. For example, multiple instances of warping engine 122 and generation engine 124 may execute on a set of nodes in a distributed and/or cloud computing system to implement the functionality of computing device 100. In another example, warping engine 122 and/or generation engine 124 may execute on various sets of hardware, types of devices, or environments to adapt warping engine 122 and/or generation engine 124 to different use cases or applications. In a third example, warping engine 122 and generation engine 124 may execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or a speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Warping engine 122 and generation engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including warping engine 122 and generation engine 124.

In one or more embodiments, warping engine 122 includes functionality to warp noise samples that are used in a reverse denoising process by a diffusion model. The warping process performed by warping engine 122 utilizes an “integral noise” representation, in which a noise sample for a discrete region (e.g., a pixel in an image) is the integral of an underlying infinite noise field. To approximate this infinite noise field, a noise value associated with a discrete region of a frame (e.g., a pixel in an image) is recursively subdivided into smaller sub-regions until a certain “level” of subdivision is reached. A different noise value for each sub-region at a given level is determined by sampling from a distribution that is parameterized according to the noise value associated with the “parent” region to which the sub-region belongs and/or the number of sub-regions into which the parent region is subdivided. During warping of noise from a noise sample for a reference frame to a noise sample for a target frame that is spatially and/or temporally correlated with the reference frame, flow vectors between the reference frame and the target frame are used to convert a discrete region in the target frame into a warped polygon within the reference frame. Noise values for the sub-regions that fall within the warped polygon are then aggregated into a noise value for the region in the target frame, thus preserving both temporal correlations between the reference frame and the target frame and properties of the distribution of noise in the noise sample for the reference frame.

Generation engine 124 uses a diffusion model to convert noise samples generated by warping engine 122 into corresponding images, video frames, and/or other types of output. More specifically, generation engine 124 may provide, as input into the diffusion model, a noise sample from warping engine 122, an input frame, a text prompt, a depth map, a pose, and/or other conditions associated with generation of a corresponding output. Generation engine 124 may use the diffusion model to denoise the noise sample into the output. During the denoising process, generation engine 124 may use cross-attention, gradient guidance, classifier-free guidance, and/or other mechanisms to align the output of each denoising step with the inputted conditions. Because each output is generated from a noise sample that reflects spatio-temporal relationships between a corresponding input frame and one or more reference frames, the output includes fewer artifacts and/or better spatio-temporal consistency than diffusion output that is generated using conventional noise sampling techniques.

Consequently, warping engine 122 and generation engine 124 may be used to perform various tasks that involve maintaining spatio-temporal consistency across multiple diffusion outputs. For example, warping engine 122 may generate a noise sample for an input target frame from a video by warping noise values from a noise sample associated with an input reference frame from the same video (e.g., a frame that precedes the input target frame within the video) according to optical flow, motion vectors, and/or other flow vectors between the reference frame and the video frame. Generation engine 124 may use text prompts, pixel values, and/or other representations of the input frames to condition the conversion of the corresponding noise samples by a diffusion model into output frames. These output frames may be used to perform video restoration, conditional video generation, video super-resolution, pose-to-person video, and/or other tasks associated with the input frames.

In other embodiments, warping engine 122 may use flow vectors representing spatial transformations between a common canonical space and a set of target spaces to warp noise samples from the canonical space to the target spaces. Generation engine 124 may use a diffusion model to denoise noise samples associated with different target spaces into corresponding output frames. Generation engine 124 may also use the flow vectors to project the output frames from the corresponding target spaces back onto the canonical space. The projected output frames may thus be used to generate visual anagrams, panoramas, anamorphic optical illusions, textures for three-dimensional (3D) meshes, infinite zoom videos, and/or other types of output that involve spatially transforming multiple outputs into a single combined output. Warping engine 122 and generation engine 124 are described in further detail below.

### Noise Warping for Diffusion Models

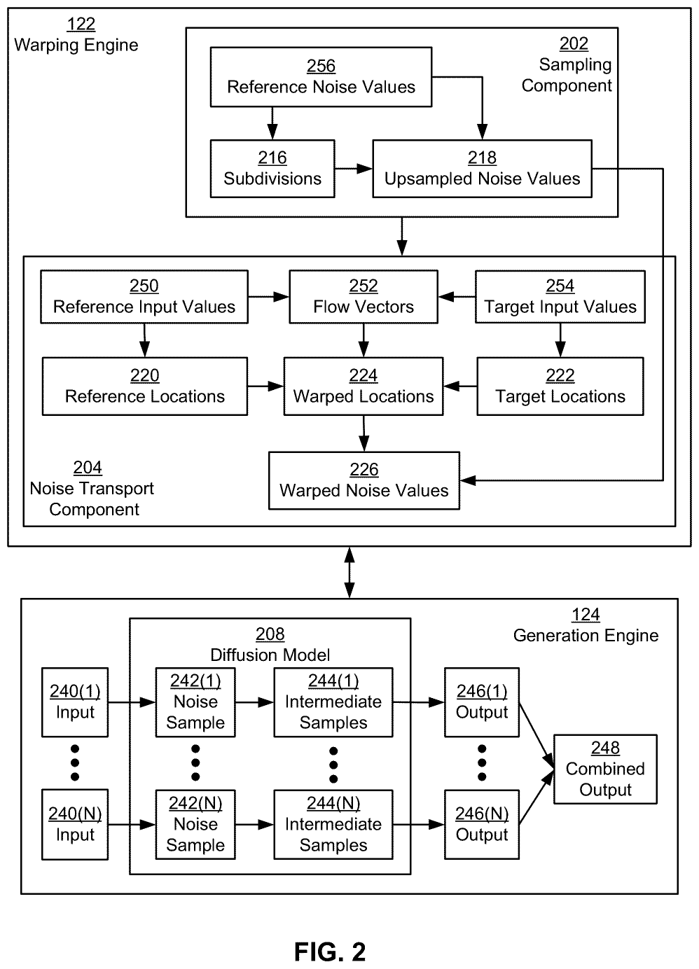

FIG. 2 is a more detailed illustration of warping engine 122 and generation engine 124 of FIG. 1, according to various embodiments. As discussed above, warping engine 122 generates noise samples 242(1)-242(N) (each of which is referred to individually herein as noise sample 242) associated with one or more target inputs 240(1)-240(N) (each of which is referred to individually herein as input 240) into a diffusion model 208 by warping reference noise values 256 included in reference noise samples 242 for reference inputs 240 that are spatially and/or temporally correlated with the target input(s) 240.

In one or more embodiments, a reference input 240 includes a representation of a first frame in a video (or another sequence or set of temporally correlated images), a frame that precedes one or more other frames within the video, and/or another type of “anchor” frame that is used as a baseline for generating and/or editing subsequent frames. Reference noise values 256 in a corresponding noise sample 242 for the reference input 240 may be generated by sampling pixel values in the reference noise sample from a Gaussian distribution. For example, a D×D region of pixels within a frame, image, and/or another two-dimensional (2D) reference input 240 may be associated with a corresponding discrete 2D Gaussian noise of the same dimensions D×D. This Gaussian noise may be represented by the function G:(i,j)∈{1, . . . , D}²→X_{i,j}, which maps a given pixel coordinate (i,j) within the region to a random variable X_{i,j}. Random variables may be assumed to be independently and identically distributed (i.i.d.) Gaussian samples X_{i,j}˜ [symbol] (0,1).

Alternatively, reference noise values 256 in a reference noise sample 242 may be generated by inverting the reference input 240. For example, a Denoising Diffusion Implicit Models (DDIM) inversion technique, null-text inversion technique, and/or another type of diffusion inversion technique may be used to transform an image and/or frame included in the reference input 240 into a corresponding latent noise representation. This latent noise representation may then be used as a reference noise sample 242 for the reference input 240.

After reference noise samples 242 are generated for one or more reference inputs 240, warping engine 122 uses the reference noise samples 242 to generate additional noise samples 242 for one or more target inputs 240 that are spatially and/or temporally correlated with the reference input(s) 240. More specifically, warping engine 122 warps reference noise values 256 in the reference noise samples 242 according to flow vectors 252 between reference input values 250 included in the reference input(s) 240 and target input values 254 included in the target input(s) 240.

In some embodiments, reference input values 250 include data and/or content from one or more reference inputs 240. For example, reference input values 250 from a reference input 240 that represents an image and/or video frame may include (but are not limited to) pixel values, depth maps, poses, semantic segmentations, texture coordinates, surface normal vectors, lighting parameters, and/or other indicators of content and/or structure within that reference input 240.

Similarly, target input values 254 include data and/or content from one or more target inputs 240. For example, target input values 254 from a target input 240 that represents an image and/or video frame may include (but are not limited to) pixel values, depth maps, poses, semantic segmentations, texture coordinates, surface normal vectors, lighting parameters, and/or other indicators of content and/or structure within that target input 240.

A noise transport component 204 in warping engine 122 computes and/or otherwise determines flow vectors 252 between reference input values 250 from one or more reference inputs 240 and target input values 254 from a given target input 240 that is spatially and/or temporally correlated with the reference input(s) 240. For example, noise transport component 204 may compute flow vectors 252 as motion vectors, optical flow fields, transformations, and/or other types of mappings between reference locations 220 associated with reference input values 250 in the reference input(s) 240 and target locations 222 associated with corresponding target input values 254 in the target input 240. These flow vectors 252 may be determined using machine learning models, optical flow estimation techniques, view-based transformation techniques, and/or other techniques.

Noise transport component 204 also uses flow vectors 252 to generate warped locations 224 that reflect correspondences between reference input values 250 and target input values 254. In one or more embodiments, warped locations 224 include reference locations 220 associated with reference input values 250 that correspond to target input values 254 at specific target locations 222 within the target input 240. Thus, noise transport component 204 may use flow vectors 252 to map one or more target locations 222 in the target input 240 to one or more corresponding warped locations 224 within the reference input(2) 240.

After warped locations 224 are determined for target locations 222 associated with a given target input 240, noise transport component 204 populates at least a portion of noise sample 242 for the target input 240 using warped noise values 226 associated with warped locations 224. These warped noise values 226 include representations of reference noise values 256 at warped locations 224 within noise samples 242 for the reference input(s) 240. For example, noise transport component 204 may generate warped noise values 226 for target locations 222 by copying and/or interpolating reference noise values 256 from the corresponding warped locations 224.

In some embodiments, warping of noise between the reference input(s) 240 and a given target input 240 is performed using an “integral” representation of reference noise values 256 in noise samples 242 for reference inputs 240. This integral noise representation reinterprets discrete (e.g., pixel-based) noise samples 242 in each reference input 240 as the integral of an underlying infinite noise field.

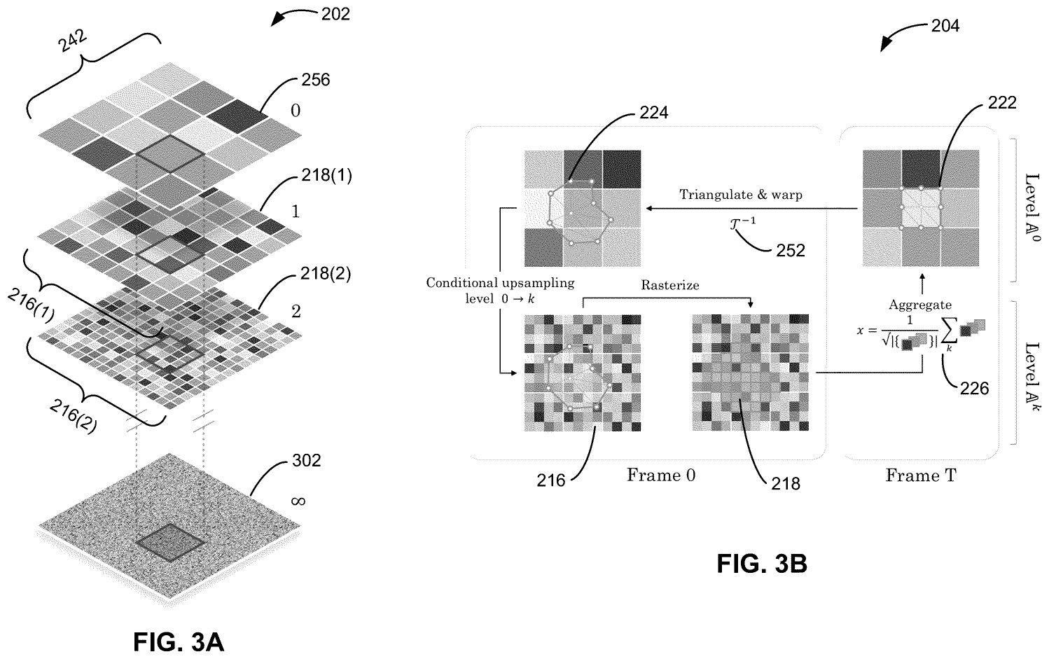

A sampling component 202 in warping engine 122 performs sampling related to reference noise values 256 to approximate the infinite noise field from which discrete reference noise values 256 in noise samples 242 for the reference inputs 240 are derived. More specifically, sampling component 202 performs recursive subdivisions 216 of regions (e.g., pixels) associated with reference noise values 256 into smaller sub-regions. Sampling component 202 also generates upsampled noise values 218 for individual sub-regions associated with a given subdivision. The operation of sampling component 202 is described in further detail below with respect to FIG. 3A.

FIG. 3A illustrates how sampling component 202 of FIG. 2 generates upsampled noise values 218 from reference noise values 256 included in a reference noise sample 242, according to various embodiments. As mentioned above, sampling component 202 uses an integral representation of noise that approximates an infinite-resolution noise field 302 underlying the reference noise sample 242 to perform recursive subdivisions 216 of regions in the reference noise sample 242 and generate upsampled noise values 218 for sub-regions within each subdivision.

As illustrated in FIG. 3A, sampling component 202 performs multiple recursive subdivisions 216(1), 216(2), etc. of regions in the reference noise sample 242 into increasingly smaller sub-regions. More specifically, sampling component 202 performs a first subdivision 216(1) of regions representing individual pixels within the reference noise sample 242 into sub-regions representing sub-pixels, where each pixel in the reference noise sample 242 is divided into four sub-pixels corresponding to quadrants within the pixel. Sampling component 202 then performs a second subdivision 216(2) of the sub-pixels in the first subdivision 216(1) into smaller sub-pixels, where each sub-pixel in the first subdivision 216(1) is further divided into four sub-pixels representing quadrants within the sub-pixel. Sampling component 202 may continue dividing each region within a given subdivision 216 into four smaller sub-regions (or a different number of smaller sub-regions) until a certain number of subdivisions 216 has been performed, region sizes within a given subdivision 216 meet or fall below a threshold, and/or another condition is met.

After a given subdivision 216 is generated, sampling component 202 generates upsampled noise values 218 for individual sub-regions within that subdivision 216. More specifically, sampling component 202 may generate upsampled noise values 218 for sub-regions within a given region by parameterizing a distribution from which these upsampled noise values 218 are sampled based on one or more attributes associated with the region and/or the corresponding subdivision 216 of the region into the sub-regions.

In one or more embodiments, the infinite-resolution noise field 302 is represented by a 2D Gaussian noise signal by endowing a 2D domain E=[0,D]×[0,D] with (i) a Borel σ-algebra ∈= [symbol] (E) that includes all possible “measurable” sets within the domain and (ii) a Lebesgue measure ν for a subset of the domain. Using this framework, the Gaussian noise on the σ-finite measure space (E, ∈, ν) is defined as a function W:A∈∈→W(A)˜ [symbol] (0, ν(A)) that maps A, which is a subset of the domain E, to a Gaussian-distributed variable with variance ν(A).

Subdivisions 216 of the domain representing the continuous noise in the infinite-resolution noise field 302 may be performed by partitioning the domain E into D×D regularly spaced, non-overlapping square subsets. This partition may be denoted as [symbol] ⁰⊆∈ and corresponds to the pixel-level reference noise values 256 in noise sample 242. The domain E may further be refined into a higher resolution set [symbol] ^{k}⊆∈, where levels k=1, 2, . . . , ∞ correspond to recursive subdivisions 216(1), 216(2), etc. of pixel-based regions in noise sample 242 into Nₖ=2^{k}×2^{k} sub-regions. Due to the properties of Gaussian noise, integrating sub-regions of the noise defined on [symbol] ^{k} maintains the properties of noise defined on [symbol] ⁰.

Assuming a single pixel sample in the domain (D=1) A⁰=[0,1]×[0,1], with [symbol] ^{k}={A₁^{k}, . . . , A_{N}_{ₖ}^{k}} representing the Nₖ sub-regions at a finer resolution k, the following holds:

$${\sum }_{i = 1}^{{N}_{k}} W ( {A}_{i}^{k} ) = W ( {⋃}_{i = 1}^{{N}_{k}} {A}_{i}^{k} ) = W ( {A}^{0} ) \qquad ( 1 )$$

The above equation indicates that the integral noise representation of a discrete region includes an integral of the Gaussian noise over a corresponding area.

Assuming that each pixel on the coarsest level [symbol] ⁰ has unit area, the noise variance νₖ=ν(Aᵢ^{k}) at each level is implicitly scaled by the sub-pixel area as νₖ=1/Nₖ. While the infinite-resolution noise field 302 [symbol] ^{∞} cannot be sampled, temporally coherent noise transport can be performed by approximating the infinite-resolution noise field 302 with a higher-resolution grid.

After obtaining an a priori noise sample 242 (e.g., from noise inversion techniques in diffusion models) at [symbol] ⁰, upsampled noise values 218 W( [symbol] ^{k}) at [symbol] ^{k} may be represented by an Nₖ-dimensional Gaussian random variable representing sub-regions of a single pixel:

$$W ( {𝔸}^{k} ) = {( W ( {A}_{1}^{k} ) , … , W ( {A}_{{N}_{k}}^{k} ) )}^{T} ∼ ( 0 , {v}_{k} I ) \qquad ( 2 )$$

Then, the conditional distribution (W( [symbol] ^{k})|W(A⁰)=x) is

$$( W ( {𝔸}^{k} ) \vert W ( {A}^{0} ) = x ) \sim 𝒩 ( \overline{μ} , \overline{Σ} ) , with \overline{μ} = \frac{x}{{N}_{k}} u , \overline{Σ} = \frac{1}{{N}_{k}} ( {I}_{{N}_{k}} - \frac{1}{{N}_{k}} {uu}^{⊤} ) \qquad ( 3 )$$

where u=(1, . . . , 1)^{T}. By setting U=\sqrt{NₖΣ}, the reparameterization trick can be used to sample W( [symbol] ^{k}) as

$$( W ( {𝔸}^{k} ) \vert W ( {A}^{0} ) = x ) = \overline{μ} + UZ = \frac{x}{{N}_{k}} u + \frac{1}{\sqrt{{N}_{k}}} ( Z - 〈 Z 〉 u ) , with Z \sim ( 0 , I ) \qquad ( 4 )$$

where [symbol] Z [symbol] is the mean of Z. For example, the noise under a pixel of value x at level k may be conditionally sampled by (i) unconditionally sampling a discrete Nₖ=2^{k}×2^{k} Gaussian sample, (i) removing the mean of the Gaussian sample, and (iii) adding the pixel value x (scaled by a scaling factor).

FIG. 3B illustrates how noise transport component 204 of FIG. 2 performs noise warping using the integral noise representation of FIG. 3A, according to various embodiments. As shown in FIG. 3B, a pixel in level [symbol] ⁰ of a “Frame T” (e.g., a frame that occupies the T^{th} position in a video and/or another temporally related sequence of frames) that corresponds to a target input 240 is subdivided into a set of target locations 222 along a boundary of the pixel. Noise transport component 204 triangulates the pixel using target locations 222 and uses flow vectors 252 to convert target locations 222 into warped locations 224 within a “Frame 0” (e.g., the first frame in a video and/or another temporally related sequence of frames) that corresponds to a reference input 240. For example, noise transport component 204 may use bicubic interpolation of pixel centers in flow vectors 252 to determine sub-pixel warped locations 224 that are mapped to target locations 222 along the boundary of the pixel.

Noise transport component 204 uses subdivisions 216 of a reference noise sample 242 for the reference input 240 to rasterize the warped triangulated shape represented by warped locations 224. Noise transport component 204 also retrieves upsampled noise values 218 for sub-regions within the rasterized shape and computes one or more warped noise values 226 for the pixel as an aggregation of these upsampled noise values 218. For example, noise transport component 204 may rasterize the warped shape into sub-regions from level [symbol] ^{k}. Noise transport component 204 may also obtain upsampled noise values 218 for the sub-regions within the warped shape and compute a warped noise value for the pixel from these upsampled noise values 218.

In one or more embodiments, flow vectors 252 correspond to a diffeomorphic deformation field [symbol] :E→E from reference locations 220 in the reference input 240 to target locations 222 in the target input 240. A continuous Gaussian noise W may be transported using [symbol] in a distribution-preserving manner using a noise transport equation that expresses the resulting noise [symbol] (W) as an Itô integral for any subset A⊆E:

$$𝒯 ( W ) ( A ) = {\int }_{x ∈ A} \frac{1}{{\vert ∇ 𝒯 ( {𝒯}^{- 1} ( x ) ) \vert}^{\frac{1}{2}}} W ( {𝒯}^{- 1} ( x ) ) dx \qquad ( 5 )$$

where |∇ [symbol] | is the determinant of the Jacobian of [symbol] . More specifically, Equation 5 is used to compute warped noise values 226 by warping a non-empty subset of the domain A using the inverse deformation field [symbol] ⁻¹ and fetching reference noise values 256 from the corresponding warped locations 224. The determinant of the Jacobian is used to rescale upsampled noise values 218 according to the amount of local stretching induced by the deformation, while also accounting for the variance change associated with Gaussian noise.

Because Equation 5 cannot be solved due to the infinite nature of the Gaussian noise, an a priori sample of the approximated infinite resolution noise field 302 (e.g., as generated using Equation 4, subdivisions 216, and upsampled noise values 218) is used to compute a higher-resolution discrete integral noise W( [symbol] ^{k}). A set of target locations 222 in a target input 240 is then warped into a corresponding set of warped locations 224, which bound a polygonal shape that is triangulated and rasterized over the higher-resolution domain [symbol] ^{k}. The sub-regions in [symbol] ^{k} that are covered by the warped shape are summed together and normalized, which yields a discrete noise transport for the warped noise value at pixel position p as:

$$G ( p ) = \frac{1}{\sqrt{\vert {Ω}_{p} \vert}} {\sum }_{{A}_{i}^{k} ∈ {Ω}_{p}} {W}_{k} ( {A}_{i}^{k} ) \qquad ( 6 )$$

In Equation 6, Wₖ=\sqrt{Nₖ}·W is the Gaussian noise scaled to unit variance at level k, and Ωₚ⊆ [symbol] ^{k} denotes all sub-regions at level k that are covered by the warped polygon, with |Ωₚ| representing the cardinality of the set. This discrete implementation preserves independence between neighboring pixels in noise sample 242 for the target input 240 because the warped polygons form a partition of the space, such that each sub-region in [symbol] ^{k} belongs only to a single warped polygon. The discrete noise transport additionally preserves the distribution of noise values across noise samples 242 by maintaining the variance of reference noise values 256 in upsampled noise values 218 and warped noise values 226.

It will be appreciated that flow vectors 252 may cause target locations 222 in a given target input 240 to have undefined warped noise values 226. These undefined warped noise values 226 can be caused by warping of target locations 222 into warped locations 224 that do not rasterize into any sub-regions within a reference input 240. This lack of reference input 240 coverage may result from a large deformation in target locations 222 and/or a lack of granularity in the sub-regions used to approximate the integral noise representation (e.g., when the highest level k associated with subdivisions 216 is too low). Undefined warped noise values 226 can also, or instead, be caused when two sets of warped locations 224 (e.g., corresponding to two different sets of target locations 222 in the target input 240) are rasterized into the same sub-regions. Because the rasterized sub-regions are used to generate only one warped noise value, the other set of target locations 222 is associated with an undefined warped noise value.

To handle non-diffeomorphic flow vectors 252 (e.g., due to discontinuities and disocclusions) that result in undefined warped noise values 226, noise transport component 204 may generate warped noise values 226 for a given target input 240 over a multi-stage process. In a first stage, noise from an “anchor” input 240 (e.g., “Frame 0” in FIG. 3B) is warped and used to generate one set of warped noise values 226 for the target input 240. In a second stage, noise from a previous input 240 (e.g., a frame that precedes “Frame T” in FIG. 3B) is upsampled and warped into a second set of warped noise values 226 for the target input 240. Additional stages may optionally be performed using other reference inputs 240 with existing noise samples 242 to fill in additional sets of warped noise values 226 for the target input 240. After all stages are performed, any undefined noise values associated with the target input 240 are replaced with randomly sampled noise.

Returning to the discussion of FIG. 2, generation engine 124 uses diffusion model 208 to convert noise samples 242 and/or the corresponding inputs 240 into a set of outputs 246(1)-246(N) (each of which is referred to individually herein as output 246). In particular, generation engine 124 initializes diffusion model 208 with a given input 240 and/or a corresponding noise sample 242 generated by warping engine 122. Generation engine 124 uses diffusion model 208 to iteratively denoise each noise sample 242(1)-242(N) into a series of intermediate samples 244(1)-244(N) (each of which is referred to individually herein as intermediate samples 244). After a certain number of denoising steps, diffusion model 208 generates denoised output 246(1)-246(N) (each of which is referred to individually herein as output 246) corresponding to the inputted noise sample 242(1)-242(N).

In one or more embodiments, diffusion model 208 is associated with a forward diffusion process that iteratively adds Gaussian noise ∈ₜ˜ [symbol] (0, I) to a “clean” (e.g., without noise added) data sample x (e.g., image, video frame, etc.) at diffusion time step t:

$${z}_{t} = \sqrt{{α}_{t} x} + \sqrt{1 - {α}_{t} {ϵ}_{t}} \qquad ( 7 )$$

In the above equation, αₜ defines a fixed noise schedule, and zₜ is noise sample 242 at time step t=T and a noised intermediate sample at time step t∈(0, T).

Diffusion model 208 includes a neural network (or another machine learning model) that is parameterized by θ and trained to perform a denoising process that is the reverse of the forward diffusion process. More specifically, diffusion model 208 predicts the noise component ∈_{B}(zₜ;t,y) conditioned upon input 240 y (e.g., a text prompt, image, pose, etc.) and time step t. Each denoising step performed using diffusion model 208 can use classifier-free guidance (CFG) that linearly interpolates a conditioned denoising step (e.g., using y as a condition) and an unconditional denoising step:

$${\hat{ϵ}}_{t} = ( 1 + ω ) {ϵ}_{θ} ( {z}_{t} ; t , y ) - {ωϵ}_{θ} ( {z}_{t} ; t ) \qquad ( 8 )$$

In the above equation, ω is a classifier-free guidance scale that controls the level of influence of the condition on the resulting generation.

The revised denoising prediction \hat{∈}ₜ is used to generate an intermediate sample zₜ and estimate a corresponding clean data sample \hat{x}ₜ for timestep t:

$${\hat{x}}_{t} = ( {z}_{t} - \sqrt{1 - {α}_{t} {\hat{ϵ}}_{t}} ) / \sqrt{{α}_{t}} \qquad ( 9 )$$

A sampling scheme such as (but not limited to) DDIM may be used to iteratively predict each intermediate sample during the denoising process:

$${z}_{t - 1} = \sqrt{{α}_{t - 1} {\hat{x}}_{t}} + \sqrt{1 - {α}_{t - 1} - {σ}_{t}^{2} {\hat{ϵ}}_{t}} + {σ}_{t} {ϵ}_{t} \qquad ( 10 )$$

where σₜ controls the stochasticity of the sampling process.

In one or more embodiments, warping engine 122 and generation engine 124 use diffusion model 208 and noise samples 242 to generate temporally correlated output 246 such as (but not limited to) video frames. More specifically, warping engine 122 generates temporally correlated noise samples 242 across a sequence of input 240 frames using the integral noise representation and warping techniques discussed above. Generation engine 124 uses diffusion model 208 to convert each noise sample 242 (conditioned on a corresponding input 240) into a different output 246 frame. After all inputs 240 and corresponding noise samples 242 have been converted into corresponding outputs 246, generation engine 124 generates a combined output 248 as a video (or another type of content) that includes a sequence of output 246 frames.

Consequently, warping engine 122 and generation engine 124 can be used to perform various tasks related to videos and/or other sequences of temporally correlated inputs 240. For example, warping engine 122 and generation engine 124 may perform video appearance transfer, video restoration, video super-resolution, pose-to-person video generation, and/or fluid simulation super-resolution using input 240 representing video frames and noise samples 242 that reflect temporal correlations across the video frames.

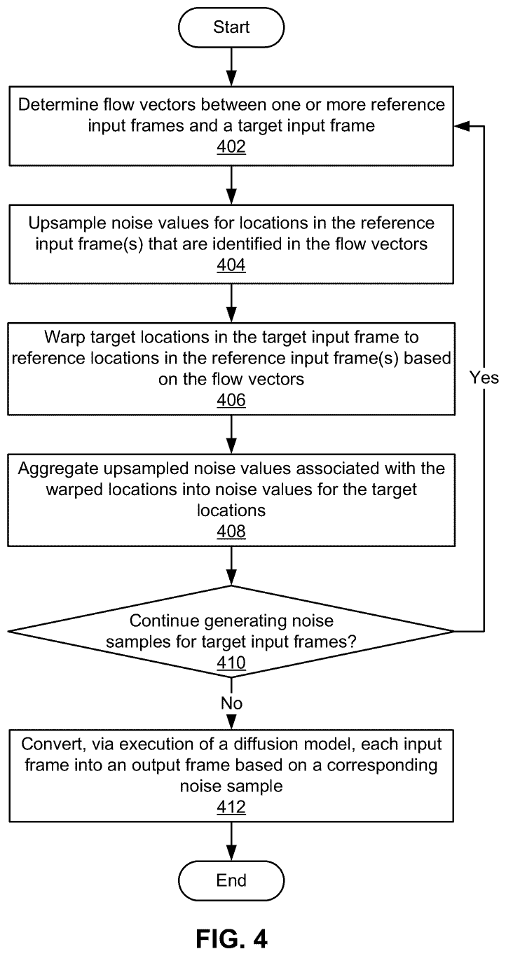

FIG. 4 is a flow diagram of method steps for generating a sequence of output frames, according to various embodiments. Although the method steps are described in conjunction with the systems of FIGS. 1-2, persons skilled in the art will understand that any system configured to perform some or all of the method steps in any order falls within the scope of the present disclosure.

As shown, in step 402, warping engine 122 determines flow vectors between one or more reference input frames and a target input frame. The reference input frame(s) may include the first frame in a video, a frame that temporally precedes the target input frame within a video, and/or another frame that is used as a baseline and/or reference for data and/or content in the target input frame. The flow vectors may include motion vectors, optical flow fields, and/or other mappings that indicate motion and/or correspondences between locations in the reference input frame(s) and the reference target frame.

In step 404, warping engine 122 upsamples noise values for locations in the reference input frame(s) that are identified in the flow vectors. For example, warping engine 122 may recursively subdivide each region (e.g., pixel) within the reference input frame(s) that is associated with a discrete noise value into multiple sub-regions. Warping engine 122 may also generate an upsampled noise value for each sub-region by sampling from a distribution with a mean that is based on the noise value for the parent region and a variance that is based on the number of sub-regions into which the parent region is divided. Warping engine 122 may recursively repeat the process with the sub-regions until a certain level of subdivision is reached, the size of each sub-region meets or falls below a threshold, and/or another condition is met.

In step 406, warping engine 122 warps target locations in the target input frame to reference locations in the reference input frame(s) based on the flow vectors. For example, warping engine 122 may generate different sets of target locations as points along the boundaries of individual pixels within the target input frame. Warping engine 122 may use a bicubic interpolation of flow vectors between the centers of pixels in the target input frame to centers of corresponding pixels in the reference input frame(s) to warp each set of target locations to a corresponding set of reference locations within a reference input frame.

In step 408, warping engine 122 aggregates upsampled noise values associated with the warped locations into noise values for the target locations. For example, warping engine 122 may rasterize a warped polygon that is bounded by a set of warped locations into sub-regions associated with the highest-level subdivision of regions in the reference input frame(s). Warping engine 122 may then compute a noise value for a region represented by the corresponding set of target locations by summing the noise values for sub-regions within the warped polygon and normalizing the result. If any regions in the target input frame are still associated with undefined noise values after warping of noise from the reference input frame(s) is complete, warping engine 122 may replace the undefined noise values with randomly sampled noise values.

In step 410, warping engine 122 determines whether or not to continue generating noise samples for target input frames. For example, warping engine 122 may determine that noise samples should continue to be generated for remaining target input frames that are temporally correlated with the reference input frame(s). While warping engine 122 determines that noise samples should continue to be generated for target input frames, warping engine 122 repeats steps 402, 404, 406, and 408 to generate a noise sample for each target input frame from warped noise values associated with the reference input frame(s). Warping engine 122 also repeats step 410 to determine whether or not to continue generating noise samples for target input frames.

After warping engine 122 determines that noise samples should no longer be generated for target input frames, generation engine 124 performs step 412, in which generation engine 124 converts, via execution of a diffusion model, each input frame into an output frame based on a corresponding noise sample. For example, generation engine 124 may input each noise sample into the diffusion model. Generation engine 124 may also use a prompt, pixel values, pose, depth maps, and/or other data from a corresponding input frame to condition the denoising of the noise sample by the diffusion model into a corresponding output frame. Because warped noise samples for the input frames preserve noise distributions of the reference input frame(s) and maintain temporal consistency with the content of the input frames, output frames produced by the diffusion model may include fewer artifacts than video-based diffusion output that is generated from fixed noise, independently sampled noise, and/or noise that is generated using traditional interpolation techniques that do not preserve noise distributions.

Returning to the discussion of FIG. 2, in some embodiments, warping engine 122 and generation engine 124 include functionality to generate combined output 248 that incorporates flow vectors 252 representing spatial transformations between a common canonical space and a set of target spaces. Each target space is associated with a different output 246 that is generated by diffusion model 208 based on a prompt and/or other conditions. Combined output 248 may then be generated by projecting outputs 246 associated with the target spaces back onto the canonical space using the corresponding flow vectors 252.

More specifically, a canonical space C is used as a canvas for combined output 248, with flow vectors 252 defined relative to the canonical space. Individual regions within the canonical space are transformed via flow vectors 252 into N different target spaces [symbol] ₀, . . . , [symbol] _{N-1}, where each target space represents a discrete output 246 with a resolution of [symbol] ^{H×W×3}.

Each transformation Fᵢ: [symbol] → [symbol] ᵢ is a view of the canonical space. Given corresponding prompts y₀, . . . , y_{N-1}, generation engine 122 uses diffusion model 208 to generate a set of N outputs 246 x₀∈ [symbol] ₀, . . . , x_{N-1}∈ [symbol] _{N-1} corresponding to the N target spaces. For example, generation engine 122 may use a prompt (or another type of input 240) for each target space to condition the generation of a corresponding output 246 by diffusion model 208. Each generated output 246 may thus include an image (or another type of output) that depicts the content described in and/or represented by a corresponding input 240.

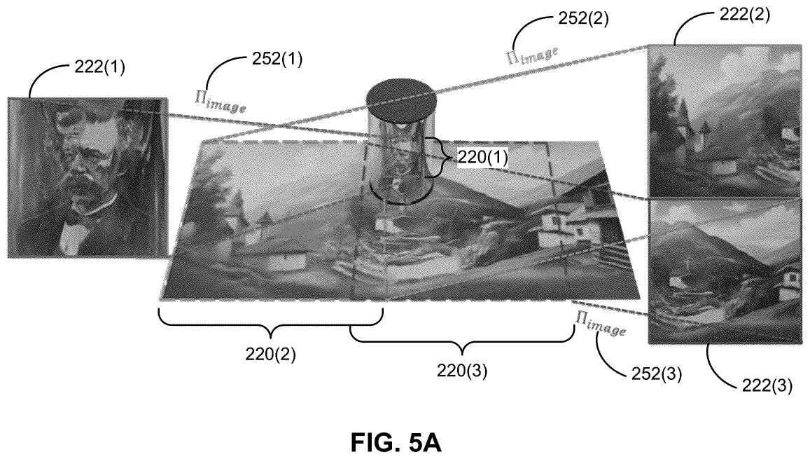

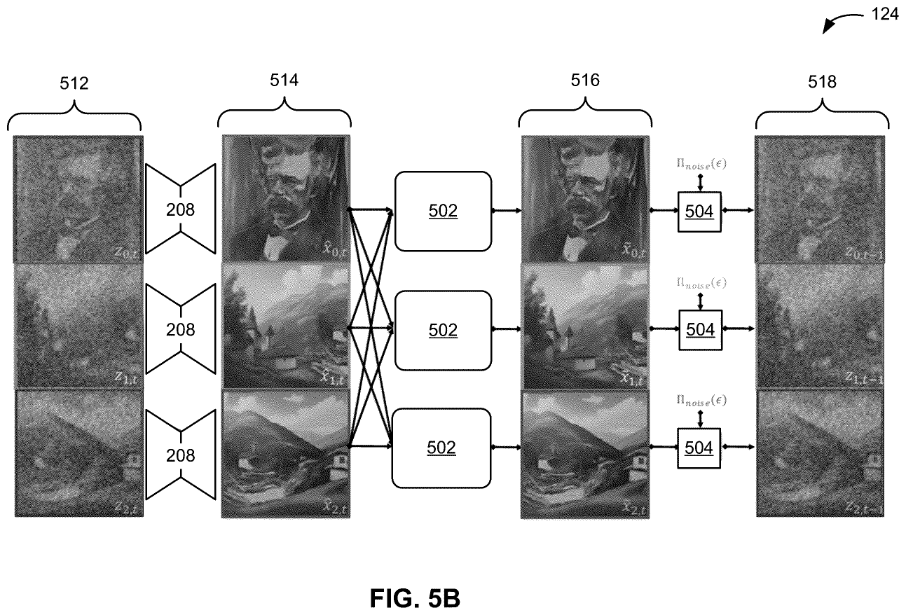

FIG. 5A illustrates how flow vectors 252 of FIG. 2 are used to warp between a set of reference locations 220 in a canonical space and multiple sets of target locations 222 in multiple corresponding target spaces, according to various embodiments. As shown in FIG. 5A, three sets of flow vectors 252(1)-252(3) denoted by Π_{image} define transformations between three sets of reference locations 220(1)-220(3) in the canonical space and three corresponding sets of target locations 222(1)-222(3) in three different target spaces. Flow vectors 252(1) map target locations 222(1) in a first rectangular target space onto a first set of reference locations 220(1) that define a region on the surface of a cylindrical shape in the canonical space. Flow vectors 252(2) map target locations 222(2) in a second rectangular target space onto a second set of reference locations 220(2) that define a first region within a planar surface of the canonical space on which the cylindrical shape is placed. Flow vectors 252(3) map target locations 222(3) in a third rectangular target space onto a third set of reference locations 220(3) that define a second region within the planar surface of the canonical space. The first and second regions of the planar surface to which target locations 222(2) and 222(3) are mapped overlap slightly.

Each target space includes a different output 246 that is projected onto the canonical space using the corresponding flow vectors 252(1)-252(3). These outputs 246 may be generated to produce an anamorphic illusion, in which a new image (e.g., the image of a face depicted in output 246 associated with target locations 222(1)) is revealed by placing a cylindrical mirror on top of an existing image (e.g., the landscape depicted in the planar surface of the canonical space onto which output 246 associated with target locations 222(2)-222(3) is projected) and looking through the mirror at around a 45 degree angle.

In one or more embodiments, each set of flow vectors 252 that transforms between reference locations 220 in the canonical space and target locations 222 in a target space is stored as a flow of size H×W×2 that indicates how target locations 222 of pixels in the target space map to 2D reference locations 220 in the canonical space. Because these 2D reference locations 220 do not necessarily correspond to pixel locations, bilinear and/or bicubic interpolation may be used to determine a color value (and/or another type of output 246 value) at a given 2D reference location.

Returning to the discussion of FIG. 2, warping engine 122 samples reference noise values 256 in a given noise sample 242 for the canonical space from a Gaussian distribution. Warping engine 122 also generates subdivisions 216 and upsampled noise values 218 from reference noise values 256 using the integral noise representation. Warping engine 122 then generates noise samples 242 for individual target spaces by warping and aggregating upsampled noise values 218 for reference locations 220 to which target locations 222 in the target spaces are mapped (e.g., using flow vectors 252), as discussed above.

For example, each pixel in a target space may be triangularized with a certain step size s, and the transformation from the pixel to a set of reference locations 220 in the canonical space is evaluated at target locations 222 of vertices in the triangularized pixel. This evaluation may be performed efficiently by discretizing flow vectors 252 on an image of size (s·H+1)×(s·W+1). The transformation is used to warp the vertices to the corresponding reference locations 220 in the canonical space, and the triangles may be rasterized on a higher-resolution grid of size H′×W′×2 that represents the canonical space. Reference locations 220 without any indices in the grid are set to −1, and Fᵢ interchangeably designates the ith view and the corresponding grid of indices in the canonical space.

Using this view representation, the computation of noise for the ith target space can be defined through a noise rendering function ∈^{F}^{ᵢ}=Πₙₒᵢₛₑ (∈,Fᵢ)∈ [symbol] ᵢ. This function takes as input a Gaussian noise sample ∈ in the canonical space [symbol] and a view Fᵢ and outputs a noise sample in the target space [symbol] ᵢ that is consistent with ∈. The function is defined for a target location corresponding to a coordinate (k,l) in the target space as:

$${ϵ}^{{F}_{i}} ( k , l ) = \frac{1}{\sqrt{\vert {𝒜}_{k , l} ( {F}_{i} ) \vert}} {\sum }_{( m , n ) ∈ {𝒜}_{k , l} ( {F}_{i} )} ε ( m , n ) \qquad ( 5 )$$

where [symbol] _{k,l}(Fᵢ) is the set of pixels {(m, n)∈[0,H′−1]×[0, W′−1]} that map all (m, n) reference locations from the grid representing the canonical space [symbol] to the (k, l) pixel in the target space. Scaling the rendering function by the inverse root of the cardinality of the set | [symbol] | allows the variance of the resulting variable to be the same as the standard Gaussian.

The same view representation can be used to warp images (and/or other types of intermediate samples 244 and/or output 246) between the canonical space [symbol] and the target space [symbol] ᵢ. An image rendering function x^{F}^{ᵢ}=Π_{image} ( [symbol] , Fᵢ)∈ [symbol] ᵢ takes an image [symbol] defined in [symbol] and warps the image to the view Fᵢ. The image rendering function is defined as:

$${x}^{{F}_{i}} ( k , l ) = \frac{1}{\vert {𝒜}_{k , l} ( {F}_{i} ) \vert} ( m , n ) \qquad ( 11 )$$

The image rendering function thus accounts for all pixels (m, n) in the canonical space [symbol] that contribute to the value of the pixel (k, l) in the target space [symbol] ᵢ.

The inverse rendering function [symbol] ^{F}^{ᵢ}=Π_{image}⁻¹(x, Fᵢ)∈ [symbol] can also be obtained for an image by replacing the pixel values back into the canonical space [symbol] :

$${{F}_{i}}^{} ( m , n ) = x ( k , l ) , ∀ ( m , n ) ∈ {𝒜}_{k , l} ( {F}_{i} ) \qquad ( 12 )$$

During inverse rendering, zeros may be assigned to pixels in the canonical space that are not present in the target space (e.g., pixels that are set to −1).

It will be appreciated that spatial transforms between the canonical space and target space may include discontinuities. For example, the mapping of a cylinder onto a plane may create a periodic seam. During triangularization of target locations 222 in a target space, vertices of certain triangles can lie on either side of a discontinuity and be mapped to drastically different locations in canonical space. These discontinuities may be handled by using Laplacian filters to detect and prune these triangles.

In one or more embodiments, generation engine 124 blends intermediate samples 244 generated by diffusion model 208 at each diffusion time step to maintain spatial consistency with one another when projected back into the canonical space [symbol] . More specifically, at each time step t, a mutually consistent predicted clean image \tilde{x}_{i,t} is predicted for each view Fᵢ. Together with a view-consistent noise ∈ᵢ, a DDIM step is performed to obtain a corresponding intermediate sample z_{i,t-1} for the previous time step t−1.

Given a set \hat{x}_{0,t}, . . . , \hat{x}_{N-1,t} of predicted clean images for each target space [symbol] ᵢ∈ [symbol] ₀, . . . , [symbol] _{N-1} at diffusion time step t, the clean images are blended by solving the following least squares problem for each view separately:

$${\tilde{x}}_{i , t} = {arg min}_{x ∈ 𝒟} {\sum }_{j = 0 , j \neq i}^{N - 1} {‖ {Π}_{image} ( {Π}_{image}^{- 1} ( {\hat{x}}_{i , t} , {F}_{i} ) , {F}_{j} ) - {M}_{i}^{j} ⊗ {\hat{x}}_{j , t} ‖}_{2}^{2} \qquad ( 13 )$$

The first term in Equation 13 warps the predicted final image \hat{x}_{i,t} from a view Fᵢ to another view Fⱼ by first mapping Fᵢ to the canonical space through Π_{image}⁻¹(\hat{x}_{i,t}, Fᵢ) and then warping from the canonical space to the destination view Fⱼ. Because zeros are assigned to pixels that are not present in the target space during the inverse rendering Π_{image}⁻¹, the resulting image in view Fⱼ includes zeros in the non-overlapping region.

In the second term of Equation 13,

$${M}_{i}^{j} = \frac{{Π}_{image} ( {1}_{{F}_{i} \neq - 1} , {F}_{j} )}{{Π}_{image} ( 1 , {F}_{j} )}$$

represents a soft mask that accounts for the proportion of a pixel in view Fⱼ that is covered by view Fᵢ. The function Mᵢ^{j} is 1 in fully overlapping pixels, 0 in non-overlapping pixels, and ∈(0,1) at the boundaries. The sum iterates through all the views.

In one or more embodiments, Equation 13 is rewritten as a linear system. The linear system for the ith view is defined as:

$$[ \begin{matrix}{A}_{i}^{0} \\ {A}_{i}^{1} \\ ⋮ \\ {A}_{i}^{N - 1}\end{matrix} ] vec [ {\hat{x}}_{i , t} ] = [ \begin{matrix}vec [ {M}_{i}^{0} ⊗ {\hat{x}}_{0 , t} ] \\ vec [ {M}_{i}^{1} ⊗ {\hat{x}}_{1 , t} ] \\ ⋮ \\ vec [ {M}_{i}^{N - 1} ⊗ {\hat{x}}_{N - 1 , t} ]\end{matrix} ] \qquad ( 14 )$$

where vec[\hat{x}_{i,t}] reshapes image \hat{x}_{i,t} into a vector, and Aᵢ^{j}∈ [symbol] ^{HW×HW} is defined as

$${A}_{i}^{j} ( [ k , l ] , [ {k}^{′} , {l}^{′} ] ) = \frac{\vert {𝒜}_{{k}^{′} , {l}^{′}} ( {F}_{i} ) ⋂ {𝒜}_{k , l} ( {F}_{j} ) \vert}{\vert {𝒜}_{k , l} ( {F}_{j} ) \vert} \qquad ( 15 )$$

with [k, l] denoting the vectorized index of pixel (k, l). Equation (15) computes the proportion of the pixel (k, l) in view Fⱼ that is covered by pixel (k′, l′) in view Fᵢ. The linear system is sparse and can be solved by a sparse least squares solver efficiently. The least squares optimization may be performed at each time step of the diffusion process.

FIG. 5B illustrates how generation engine 124 of FIG. 1 performs a denoising step that maintains mutual consistency across multiple views associated with a canonical space, according to various embodiments. As shown in FIG. 5B, three noisy intermediate samples 512 denoted by z_{0,t}, z_{1,t}, and z_{2,t} are inputted into diffusion model 208. For each inputted noisy intermediate sample 512, diffusion model 208 generates a denoising prediction \hat{∈}ₜ that is used to convert the intermediate sample into a denoised intermediate sample 514 (e.g., using Equation 9). These denoised intermediate samples 514 are denoted by \hat{x}_{0,t}, \hat{x}_{1,t}, and \hat{x}_{2,t}.

Per-view least squares blending 502 is performed to blend each denoised intermediate sample 514 with the other denoised intermediate samples 514 based on overlap in the views within the canonical space. The output of least squares blending 502 includes a set of blended denoised intermediate samples 516 denoted by \tilde{x}_{0,t}, \tilde{x}_{1,t}, and \tilde{x}_{2,t}. A diffusion inversion 504 (e.g., DDIM) uses a view-consistent noise Πₙₒᵢₛₑ(∈) to convert each blended denoised intermediate samples 516 into a corresponding noisy intermediate sample 518 for the previous diffusion time step t−1. These noisy intermediate samples 518 are denoted by z_{0,t-1}, z_{1,t-1}, and z_{2,t-1}.

Returning to the discussion of FIG. 2, at the end of the diffusion process, the final combined output 248 X is synthesized in the canonical space C through another least squares optimization. Using Equation (13), this least squares optimization defines target space i as the canonical space and Fᵢ as an identity map I. All target space outputs 246 are treated as views Fⱼ. An extra regularization that dampens the least square system through averaging of the overlapping regions may be added to avoid an underconstrained system.

In one or more embodiments, the operation of generation engine 124 in generating combined output 248 that incorporates flow vectors 252 representing spatial transformations between a canonical space and a set of target spaces is represented using the following steps:
Input: ∀i∈0, . . . , N−1: view transformations Fᵢ∈R^{H′×W×2}, text prompts yᵢ, pretrained diffusion model ∈_{θ}.
Param: Classifier-free guidance scale ω, number of DDIM timesteps T.
Output: Predicted image in the world space X.

| | |
|---|---|
| 1 | ε ~ [symbol] (0, I) for i ← 0, ... , N − 1 do |
| 2 | z_{i,T} ← Πₙₒᵢₛₑ (ε; Fᵢ) |
| 3 | end |
| 4 | fort t ← T: 0 do |
| 5 | ε ~ [symbol] (0, I) |
| 6 | for i ← 0, ... , N − 1 do |
| 7 | \hat{ϵ}_{i,t} ← ClassifierFreeGuidance(ϵ_{θ}; z_{i,t}; yᵢ; ω) |
| 8 | \hat{x}_{i,t} ← PredictCleanImage(z_{i,t}; \hat{ϵ}_{i,t}) |
| 9 | end |
| 10 | for i ← 0, ... , N − 1 do |
| 11 | \tilde{x}_{i,t} ← LeastSquares(Fᵢ; ∪ⱼ₌₀^{N-1} Fⱼ;∪ⱼ₌₀^{N-1} \hat{x}_{j,t}) |
| 12 | ϵᵢ ← Πₙₒᵢₛₑ (ε; Fᵢ) |
| 13 | z_{i,t-1} ← DDIM(z_{i,t}; \tilde{x}_{i,t}; ϵᵢ) |
| 14 | end |
| 15 | end |
| 16 | X ← LeastSquares(I;∪ⱼ₌₀^{N-1} Fⱼ;∪ⱼ₌₀^{N-1} \hat{x}_{j,0}) |

Steps 1-3 generate a Gaussian noise sample 242 ∈ in the canonical space and use the noise rendering function to warp the canonical space noise sample 242 into additional noise samples 242 z_{i,T} for individual target spaces i. Steps 4-15 span an outer for loop that iterates over diffusion steps from T to 0. Each diffusion step begins with step 5, which generates another Gaussian noise sample 242 ∈. Steps 6-9 span a first inner for loop that iterates over the target spaces. During each iteration of the first inner for loop, step 7 uses diffusion model 208 with classifier-free guidance (e.g., Equation 8) to predict a noise component \hat{∈}_{i,t} associated with z_{i,t}, which represents noise sample 242 for the ith target space when t=T and a noisy intermediate sample for the ith target space when t<T. Step 8 uses Equation 9 to predict a denoised intermediate sample \hat{x}_{i,t} for the same target space from noise sample 242 and the predicted noise component.

After the first inner for loop is complete, steps 10-14 are used to execute a second inner for loop that also iterates over the target spaces. During each iteration of the second inner for loop, step 11 uses Equation 14 to generate a blended denoised intermediate sample \tilde{x}_{i,t} for the ith target space by blending the denoised intermediate sample for the same target space with other denoised intermediate samples for other target spaces. Step 12 uses the noise rendering function to warp the Gaussian noise sample 242 generated in step 5 into a corresponding noise prediction ∈ᵢ for the ith target space. Step 13 uses DDIM to generate an intermediate sample z_{i,t-1} for the same target space from z_{i,t}, the blended clean image \tilde{x}_{i,t}, and the noise prediction ∈ᵢ.

After the second inner for loop is complete, the outer for loop is repeated for additional diffusion steps. After all diffusion steps have been performed, step 16 is executed to perform another least squares optimization that generates combined output 248 by projecting and blending outputs 246 corresponding to blended clean images \tilde{x}_{i,0} for diffusion time step 0.

In one or more embodiments, combined output 248 that incorporates flow vectors 252 representing spatial transformations between a canonical space and a set of target spaces can be used to generate complex visual representations and/or optical illusions that incorporate outputs 246. For example, combined output 248 may include visual anagrams (e.g., images that can be interpreted differently when viewed from distinct perspectives) with rotation of arbitrary angles, twisting of image centers, and/or other types of transformations that are defined using flow vectors 252. In another example, combined output 248 may include anamorphic optical illusions that exhibit different outputs 246 when viewed plainly or through a conic and/or cylindrical mirror. In a third example, combined output 248 may include a panoramic image that “fills in” content between projections of outputs 246 from multiple target spaces. In a fourth example, combined output 248 may include an “infinite zoom” video that causes new content to be displayed while zooming and/or panning within an image. In a fifth example, outputs 246 may be used to texture 3D meshes by interpreting a UV mapped mesh as a view of a canonical UV space and defining a view for each rendering camera.

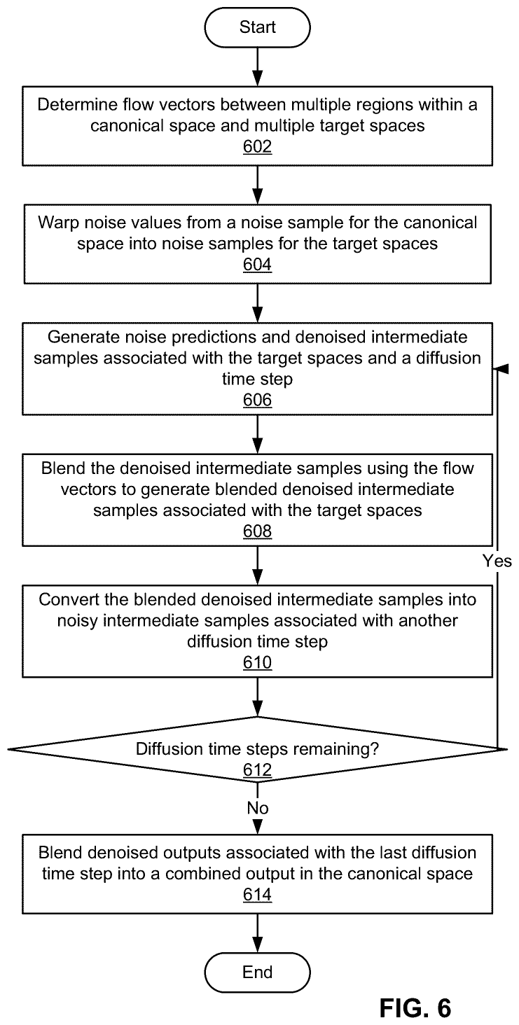

FIG. 6 is a flow diagram of method steps for generating output in a canonical space that incorporates views from different target spaces, according to various embodiments. Although the method steps are described in conjunction with the systems of FIGS. 1-2, persons skilled in the art will understand that any system configured to perform some or all of the method steps in any order falls within the scope of the present disclosure.

As shown, in step 602, warping engine 122 determines flow vectors between multiple regions within a canonical space and multiple target spaces. For example, warping engine 122 may obtain the flow vectors as spatial transformations between the regions in the canonical space and the target spaces.

In step 604, warping engine 122 warps noise values from a noise sample for the canonical space into noise samples for the target spaces. For example, warping engine 122 may generate the noise sample for the canonical space by sampling per-pixel noise values from a Gaussian distribution. Warping engine 122 may also upsample the per-pixel noise values into noise values for sub-regions of pixels in the canonical space, as discussed above. Warping engine 122 may use the flow vectors to warp pixels in the target spaces into polygons within the canonical space and aggregate upsampled noise values that fall within the polygons into corresponding noise values for the pixels.

In step 606, generation engine 124 generates noise predictions and denoised intermediate samples associated with the target spaces and a diffusion time step. For example, generation engine 124 may use classifier-free guidance with a diffusion model to generate a noise prediction for each target space from a corresponding noise sample (or a noisy intermediate sample from a previous diffusion time step) and prompt. Generation engine 124 may also generate a corresponding denoised intermediate sample by updating the noise sample with the noise prediction.

In step 608, generation engine 124 blends the denoised intermediate samples using the flow vectors to generate blended denoised intermediate samples associated with the target spaces. For example, generation engine 124 may generate a blended denoised intermediate sample for each target space by solving a least squares problem that maintains consistency across denoised intermediate samples for all target spaces.

In step 610, generation engine 124 converts the blended denoised intermediate samples into noisy intermediate samples associated with another diffusion time step. For example, generation engine 124 may use DDIM and/or another technique to generate each noisy intermediate sample from a corresponding blended denoised intermediate sample and a view-consistent noise.

In step 612, generation engine 124 determines whether or not diffusion time steps remain. For example, generation engine 124 may determine that diffusion time steps remain until a certain number of diffusion time steps have been performed. While generation engine 124 determines that diffusion time steps remain, generation engine 124 repeats steps 606, 608, and 610 to generate additional noise predictions, denoised intermediate samples, blended denoised intermediate samples, and noisy intermediate samples for the additional diffusion time steps. Generation engine 124 also repeats step 612 to determine whether or not additional diffusion time steps remain.

After generation engine 124 determines that no additional diffusion time steps remain (e.g., after the 0^{th} diffusion time step is reached), generation engine 124 performs step 614, in which generation engine 124 blends denoised outputs associated with the last diffusion time step into a combined output in the canonical space. For example, generation engine 124 may generate the combined output by performing an additional least squares optimization that maintains consistency in overlapping regions of denoised outputs that are projected from the corresponding target spaces into the canonical space.

In sum, the disclosed techniques warp noise samples that are used in a reverse denoising process by a diffusion model in a temporally consistent manner. The warping process utilizes an “integral noise” representation, in which a noise sample for a discrete region (e.g., a pixel in an image) is the integral of an underlying infinite noise field. To approximate this infinite noise field, a noise value associated with a discrete region of a frame (e.g., a pixel in an image) is recursively subdivided into smaller sub-regions until a certain “level” of subdivision is reached. A different noise value for each sub-region at a given level is determined by sampling from a distribution that is parameterized according to the noise value associated with the “parent” region to which the sub-region belongs and/or the number of sub-regions into which the parent region is subdivided.

During warping of noise from a noise sample for a reference frame to a noise sample for a target frame that is spatially and/or temporally correlated with the reference frame, flow vectors between the reference frame and the target frame are used to convert a discrete region in the target frame into a warped polygon within the reference frame. Noise values for the sub-regions that fall within the warped polygon are then aggregated into a noise value for the region in the target frame, thus preserving both temporal correlations between the reference frame and the target frame and properties of the distribution of noise in the noise sample for the reference frame.

A diffusion model is used to convert the noise samples into corresponding images, video frames, and/or other types of output. Input into the diffusion model may include a noise sample, an input frame, a text prompt, a depth map, a pose, and/or other conditions associated with generation of a corresponding output. The diffusion model iteratively denoises the noise sample into the output. During the denoising process, cross-attention, gradient guidance, classifier-free guidance, and/or other mechanisms may be used to align the output of each denoising step with the inputted conditions.

Diffusion-based generation from warped noise samples may be used to perform various tasks that involve maintaining spatio-temporal consistency across multiple diffusion outputs. For example, a noise sample for an input target frame from a video may be generated by warping noise values from a noise sample associated with an input reference frame from the same video (e.g., a frame that precedes the input target frame within the video) according to optical flow, motion vectors, and/or other flow vectors between the reference frame and the video frame. Text prompts, pixel values, and/or other representations of the input frames may then be used to condition the conversion of the corresponding noise samples by a diffusion model into output frames. These output frames may be used to perform video restoration, conditional video generation, video super-resolution, pose-to-person video, and/or other tasks associated with the input frames.

In another example, flow vectors representing spatial transformations between a common canonical space and a set of target spaces may be used to warp noise samples from the canonical space to the target spaces. A diffusion model may be used to denoise noise samples associated with different target spaces into corresponding output frames, and the flow vectors may be used to project the output frames from the corresponding target spaces back onto the canonical space. The projected output frames may thus be used to generate visual anagrams, panoramas, anamorphic optical illusions, textures for three-dimensional (3D) meshes, infinite zoom videos, and/or other types of output that involve spatially transforming multiple outputs into a single combined output.

One technical advantage of the disclosed techniques relative to the prior art is the ability to generate a noise sample for an input frame that reflects spatio-temporal relationships between the input frame and one or more reference frames. Accordingly, diffusion output that is generated from the noise sample may include fewer artifacts and/or better spatio-temporal consistency than diffusion output that is generated using conventional noise sampling techniques. Another technical advantage of the disclosed techniques is the ability to project images and/or noise from multiple target spaces onto a common canonical space during diffusion-based generation. Consequently, the disclosed techniques can be used with diffusion models to generate visual anagrams with arbitrary rotations and/or transformations, computational optical illusions, infinite zoom videos, image panoramas, and/or other types of complex visual output. These technical advantages provide one or more technological improvements over prior art approaches.

1. In some embodiments, a computer-implemented method for generating data comprises determining a first set of flow vectors between a first input frame and a second input frame; generating, based on the first set of flow vectors and a first noise sample associated with the first input frame, a second noise sample associated with the second input frame; converting, via execution of a diffusion model, the first input frame into a first output frame based on the first noise sample; and converting, via execution of the diffusion model, the second input frame into a second output frame based on the second noise sample.

2. The computer-implemented method of clause 1, further comprising determining a second set of flow vectors between a third input frame and the second input frame; and further generating the second noise sample based on the second set of flow vectors and a third noise sample associated with the third input frame.

3. The computer-implemented method of any of clauses 1-2, wherein the third input frame temporally precedes the second input frame within a video.

4. The computer-implemented method of any of clauses 1-3, wherein generating the second noise sample comprises upsampling a first plurality of noise values included in the first noise sample into a second plurality of noise values; and determining a third plurality of noise values included in the second noise sample based on the second plurality of noise values and the first set of flow vectors.

5. The computer-implemented method of any of clauses 1-4, wherein upsampling the first plurality of noise values into the second plurality of noise values comprises dividing a region of the first input frame that is associated with a noise value included in the first plurality of noise values into a plurality of sub-regions; and generating, based on the noise value, a plurality of upsampled noise values associated with the plurality of sub-regions.

6. The computer-implemented method of any of clauses 1-5, wherein generating the plurality of upsampled noise values comprises sampling each upsampled noise value included in the plurality of upsampled noise values from a distribution that is parameterized by the noise value.

7. The computer-implemented method of any of clauses 1-6, wherein determining the third plurality of noise values comprises matching, based on the first set of flow vectors, a first plurality of locations within the second input frame to a second plurality of locations within the first input frame; and aggregating a subset of the second plurality of noise values associated with the second plurality of locations into a noise value that is (i) associated with the first plurality of locations and (ii) included in the third plurality of noise values.

8. The computer-implemented method of any of clauses 1-7, further comprising determining a second set of flow vectors between the first input frame and a third input frame; generating, based on the second set of flow vectors and the first noise sample associated with the first input frame, a third noise sample associated with the third input frame; and converting, via execution of the diffusion model, the third input frame into a third output frame based on the third noise sample.

9. The computer-implemented method of any of clauses 1-8, wherein the first input frame comprises a starting frame within a video and the second input frame temporally follows the first input frame within the video.

10. The computer-implemented method of any of clauses 1-9, wherein the first set of flow vectors comprises at least one of a motion vector or an optical flow.

11. In some embodiments, one or more non-transitory computer-readable media store instructions that, when executed by one or more processors, cause the one or more processors to perform the steps of determining a first set of flow vectors between a first input frame and a second input frame; generating, based on the first set of flow vectors and a first noise sample associated with the first input frame, a second noise sample associated with the second input frame; converting, via execution of a diffusion model, the first input frame into a first output frame based on the first noise sample; and converting, via execution of the diffusion model, the second input frame into a second output frame based on the second noise sample.

12. The one or more non-transitory computer-readable media of clause 11, wherein the instructions further cause the one or more processors to perform the steps of determining a second set of flow vectors between a third input frame and the second input frame; and further generating the second noise sample based on the second set of flow vectors and a third noise sample associated with the third input frame.

13. The one or more non-transitory computer-readable media of any of clauses 11-12, wherein further generating the second noise sample comprises upsampling a first plurality of noise values included in the third noise sample into a second plurality of noise values; determining a first plurality of locations within the second input frame that are associated with undefined noise values; matching, based on the second set of flow vectors, the first plurality of locations to a second plurality of locations within the third input frame; and aggregating a subset of the second plurality of noise values associated with the second plurality of locations into a first noise value that is (i) associated with the first plurality of locations and (ii) included in the second noise sample.

14. The one or more non-transitory computer-readable media of any of clauses 11-13, wherein generating the second noise sample comprises upsampling a first plurality of noise values included in the first noise sample into a second plurality of noise values; matching, based on the first set of flow vectors, a first plurality of locations within the second input frame to a second plurality of locations within the first input frame; and aggregating a subset of the second plurality of noise values associated with the second plurality of locations into a second noise value that is (i) associated with the first plurality of locations and (ii) included in the second noise sample.

15. The one or more non-transitory computer-readable media of any of clauses 11-14, wherein upsampling the first plurality of noise values into the second plurality of noise values comprises dividing a region of the first input frame that is associated with a noise value included in the first plurality of noise values into a plurality of sub-regions; and generating a plurality of upsampled noise values associated with the plurality of sub-regions based on the noise value.

16. The one or more non-transitory computer-readable media of any of clauses 11-15, wherein generating the plurality of upsampled noise values comprises sampling each upsampled noise value included in the plurality of upsampled noise values from a distribution with a mean that is determined based on the noise value and a variance that is determined based on a number of sub-regions included in the plurality of sub-regions.

17. The one or more non-transitory computer-readable media of any of clauses 11-16, wherein the first plurality of locations is included in a pixel within the second input frame.

18. The one or more non-transitory computer-readable media of any of clauses 11-17, wherein the first input frame temporally precedes the second input frame.

19. The one or more non-transitory computer-readable media of any of clauses 11-18, wherein the first output frame and the second output frame comprise at least one of edits to the first input frame and the second input frame, restoration of the first input frame and the second input frame, one or more conditions specified in the first input frame and the second input frame, or higher-resolution versions of the first input frame and the second input frame.

20. In some embodiments, a system comprises one or more memories that store instructions, and one or more processors that are coupled to the one or more memories and, when executing the instructions, are configured to perform the steps of determining a first set of flow vectors between a first input frame and a second input frame; generating, based on the first set of flow vectors and a first noise sample associated with the first input frame, a second noise sample associated with the second input frame; converting, via execution of a diffusion model, the first input frame into a first output frame based on the first noise sample; and converting, via execution of the diffusion model, the second input frame into a second output frame based on the second noise sample.

21. In some embodiments, a computer-implemented method for generating data comprises determining a plurality of flow vectors between a plurality of regions within a canonical space and a plurality of target spaces; generating, based on the plurality of flow vectors and a first noise sample associated with the canonical space, a plurality of noise samples associated with the plurality of target spaces; generating, via execution of a diffusion model based on the plurality of noise samples, a plurality of denoised intermediate samples associated with the plurality of target spaces; blending the plurality of denoised intermediate samples based on the plurality of flow vectors to generate a plurality of blended denoised intermediate samples associated with the plurality of target spaces; and generating an output frame based on the plurality of blended denoised intermediate samples, wherein the output frame comprises a projection of a plurality of diffusion outputs that correspond to the plurality of blended denoised intermediate samples from the plurality of target spaces onto the plurality of regions within the canonical space.

22. The computer-implemented method of clause 21, wherein generating the plurality of noise samples comprises upsampling a first plurality of noise values included in the first noise sample into a second plurality of noise values; matching, based on the plurality of flow vectors, a first plurality of locations within the canonical space to a second plurality of locations within a target space that is included in the plurality of target spaces; and aggregating a subset of the second plurality of noise values associated with the second plurality of locations into a first noise value that is (i) associated with the first plurality of locations and (ii) included in the target space.

23. The computer-implemented method of any of clauses 21-22, wherein upsampling the first plurality of noise values into the second plurality of noise values comprises dividing a region of the canonical space that is associated with a second noise value included in the first plurality of noise values into a plurality of sub-regions; and generating a plurality of upsampled noise values associated with the plurality of sub-regions based on the second noise value.

24. The computer-implemented method of any of clauses 21-23, wherein generating the plurality of upsampled noise values comprises sampling each upsampled noise value included in the plurality of upsampled noise values from a distribution that is parameterized by the second noise value.

25. The computer-implemented method of any of clauses 21-24, wherein generating the plurality of denoised intermediate samples comprises generating, via execution of the diffusion model, a noise prediction associated with a noise sample included in the plurality of noise samples; and updating the noise sample based on the noise prediction to generate a denoised intermediate sample that is included in the plurality of denoised intermediate samples.

26. The computer-implemented method of any of clauses 21-25, wherein blending the plurality of denoised intermediate samples comprises generating a blended denoised intermediate sample included in the plurality of blended denoised intermediate samples based on an overlap of a corresponding denoised intermediate sample with one or more additional denoised intermediate samples included in the plurality of denoised intermediate samples.

27. The computer-implemented method of any of clauses 21-26, wherein the plurality of blended denoised intermediate samples is generated via a least squares optimization associated with the plurality of denoised intermediate samples.

28. The computer-implemented method of any of clauses 21-27, wherein generating the output frame comprises converting the plurality of blended denoised intermediate samples associated with a first diffusion time step into a plurality of noisy intermediate samples associated with a second diffusion time step; generating the plurality of diffusion outputs based on the plurality of noisy intermediate samples; and combining the plurality of diffusion outputs into the output frame.

29. The computer-implemented method of any of clauses 21-28, wherein each denoised intermediate sample included in the plurality of denoised intermediate samples is further generated based on a set of conditions.

30. The computer-implemented method of any of clauses 21-29, wherein the set of conditions comprises at least one of a prompt, a pixel value, or a pose.

31. In some embodiments, one or more non-transitory computer-readable media store instructions that, when executed by one or more processors, cause the one or more processors to perform the steps of determining a plurality of flow vectors between a plurality of regions within a canonical space and a plurality of target spaces; generating, based on the plurality of flow vectors and a first noise sample associated with the canonical space, a plurality of noise samples associated with the plurality of target spaces; generating, via execution of a diffusion model based on the plurality of noise samples, a plurality of denoised intermediate samples associated with the plurality of target spaces; blending the plurality of denoised intermediate samples based on the plurality of flow vectors to generate a plurality of blended denoised intermediate samples associated with the plurality of target spaces; and generating an output frame based on the plurality of blended denoised intermediate samples, wherein the output frame comprises a projection of a plurality of diffusion outputs that correspond to the plurality of blended denoised intermediate samples from the plurality of target spaces onto the plurality of regions within the canonical space.

32. The one or more non-transitory computer-readable media of clause 31, wherein generating the plurality of noise samples comprises upsampling a first plurality of noise values included in the first noise sample into a second plurality of noise values; matching, based on the plurality of flow vectors, a first plurality of locations within the canonical space to a second plurality of locations within a target space that is included in the plurality of target spaces; and aggregating a subset of the second plurality of noise values associated with the second plurality of locations into a first noise value that is (i) associated with the first plurality of locations and (ii) included in the target space.

33. The one or more non-transitory computer-readable media of any of clauses 31-32, wherein upsampling the first plurality of noise values into the second plurality of noise values comprises dividing a region of the canonical space that is associated with a second noise value included in the first plurality of noise values into a plurality of sub-regions; and generating a plurality of upsampled noise values associated with the plurality of sub-regions based on the second noise value.

34. The one or more non-transitory computer-readable media of any of clauses 31-33, wherein generating the plurality of upsampled noise values comprises sampling each upsampled noise value included in the plurality of upsampled noise values from a distribution with a mean that is determined based on the second noise value and a variance that is determined based on a number of sub-regions included in the plurality of sub-regions.

35. The one or more non-transitory computer-readable media of any of clauses 31-34, wherein generating the plurality of denoised intermediate samples comprises generating, via execution of the diffusion model, a noise prediction associated with a noise sample included in the plurality of noise samples; and updating the noise sample based on the noise prediction to generate a denoised intermediate sample that is included in the plurality of denoised intermediate samples.

36. The one or more non-transitory computer-readable media of any of clauses 31-35, wherein blending the plurality of denoised intermediate samples comprises generating a blended denoised intermediate sample included in the plurality of blended denoised intermediate samples based on a first set of pixel values from a corresponding denoised intermediate sample and one or more additional sets of pixel values from one or more additional denoised intermediate samples included in the plurality of denoised intermediate samples.

37. The one or more non-transitory computer-readable media of any of clauses 31-36, wherein generating the output frame comprises converting the plurality of blended denoised intermediate samples associated into the plurality of diffusion outputs; and combining the plurality of diffusion outputs into the output frame.

38. The one or more non-transitory computer-readable media of any of clauses 31-37, wherein the plurality of flow vectors comprises a mapping between (i) a first location in the canonical space and (ii) a second location in a target space included in the plurality of target spaces.

39. The one or more non-transitory computer-readable media of any of clauses 31-38, wherein the output frame comprises at least one of a visual anagram, an anamorphic illusion, a panorama, an infinite zoom video, or a texture for a mesh.

40. In some embodiments, a system comprises one or more memories that store instructions, and one or more processors that are coupled to the one or more memories and, when executing the instructions, are configured to perform the steps of determining a plurality of flow vectors between a plurality of regions within a canonical space and a plurality of target spaces; generating, based on the plurality of flow vectors and a first noise sample associated with the canonical space, a plurality of noise samples associated with the plurality of target spaces; generating, via execution of a diffusion model based on the plurality of noise samples, a plurality of denoised intermediate samples associated with the plurality of target spaces; blending the plurality of denoised intermediate samples based on the plurality of flow vectors to generate a plurality of blended denoised intermediate samples associated with the plurality of target spaces; and generating an output frame based on the plurality of blended denoised intermediate samples, wherein the output frame comprises a projection of a plurality of diffusion outputs that correspond to the plurality of blended denoised intermediate samples from the plurality of target spaces onto the plurality of regions within the canonical space.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating data, the method comprising:
determining a first set of flow vectors between a first input frame and a second input frame;
generating, based on the first set of flow vectors and a first noise sample associated with the first input frame, a second noise sample associated with the second input frame;
converting, via execution of a diffusion model, the first input frame into a first output frame based on the first noise sample; and
converting, via execution of the diffusion model, the second input frame into a second output frame based on the second noise sample.

2. The computer-implemented method of claim 1, further comprising:
determining a second set of flow vectors between a third input frame and the second input frame; and
further generating the second noise sample based on the second set of flow vectors and a third noise sample associated with the third input frame.

3. The computer-implemented method of claim 2, wherein the third input frame temporally precedes the second input frame within a video.

4. The computer-implemented method of claim 1, wherein generating the second noise sample comprises:
upsampling a first plurality of noise values included in the first noise sample into a second plurality of noise values; and
determining a third plurality of noise values included in the second noise sample based on the second plurality of noise values and the first set of flow vectors.

5. The computer-implemented method of claim 4, wherein upsampling the first plurality of noise values into the second plurality of noise values comprises:
dividing a region of the first input frame that is associated with a noise value included in the first plurality of noise values into a plurality of sub-regions; and
generating, based on the noise value, a plurality of upsampled noise values associated with the plurality of sub-regions.

6. The computer-implemented method of claim 5, wherein generating the plurality of upsampled noise values comprises sampling each upsampled noise value included in the plurality of upsampled noise values from a distribution that is parameterized by the noise value.

7. The computer-implemented method of claim 4, wherein determining the third plurality of noise values comprises:
matching, based on the first set of flow vectors, a first plurality of locations within the second input frame to a second plurality of locations within the first input frame; and
aggregating a subset of the second plurality of noise values associated with the second plurality of locations into a noise value that is (i) associated with the first plurality of locations and (ii) included in the third plurality of noise values.

8. The computer-implemented method of claim 1, further comprising:
determining a second set of flow vectors between the first input frame and a third input frame;
generating, based on the second set of flow vectors and the first noise sample associated with the first input frame, a third noise sample associated with the third input frame; and
converting, via execution of the diffusion model, the third input frame into a third output frame based on the third noise sample.

9. The computer-implemented method of claim 1, wherein the first input frame comprises a starting frame within a video and the second input frame temporally follows the first input frame within the video.

10. The computer-implemented method of claim 1, wherein the first set of flow vectors comprises at least one of a motion vector or an optical flow.

11. One or more non-transitory computer-readable media storing instructions that, when executed by one or more processors, cause the one or more processors to perform the steps of:
determining a first set of flow vectors between a first input frame and a second input frame;
generating, based on the first set of flow vectors and a first noise sample associated with the first input frame, a second noise sample associated with the second input frame;
converting, via execution of a diffusion model, the first input frame into a first output frame based on the first noise sample; and
converting, via execution of the diffusion model, the second input frame into a second output frame based on the second noise sample.

12. The one or more non-transitory computer-readable media of claim 11, wherein the instructions further cause the one or more processors to perform the steps of:
determining a second set of flow vectors between a third input frame and the second input frame; and
further generating the second noise sample based on the second set of flow vectors and a third noise sample associated with the third input frame.

13. The one or more non-transitory computer-readable media of claim 12, wherein further generating the second noise sample comprises:
upsampling a first plurality of noise values included in the third noise sample into a second plurality of noise values;
determining a first plurality of locations within the second input frame that are associated with undefined noise values;
matching, based on the second set of flow vectors, the first plurality of locations to a second plurality of locations within the third input frame; and
aggregating a subset of the second plurality of noise values associated with the second plurality of locations into a first noise value that is (i) associated with the first plurality of locations and (ii) included in the second noise sample.

14. The one or more non-transitory computer-readable media of claim 11, wherein generating the second noise sample comprises:
upsampling a first plurality of noise values included in the first noise sample into a second plurality of noise values;
matching, based on the first set of flow vectors, a first plurality of locations within the second input frame to a second plurality of locations within the first input frame; and
aggregating a subset of the second plurality of noise values associated with the second plurality of locations into a second noise value that is (i) associated with the first plurality of locations and (ii) included in the second noise sample.

15. The one or more non-transitory computer-readable media of claim 14, wherein upsampling the first plurality of noise values into the second plurality of noise values comprises:
dividing a region of the first input frame that is associated with a noise value included in the first plurality of noise values into a plurality of sub-regions; and
generating a plurality of upsampled noise values associated with the plurality of sub-regions based on the noise value.

16. The one or more non-transitory computer-readable media of claim 15, wherein generating the plurality of upsampled noise values comprises sampling each upsampled noise value included in the plurality of upsampled noise values from a distribution with a mean that is determined based on the noise value and a variance that is determined based on a number of sub-regions included in the plurality of sub-regions.

17. The one or more non-transitory computer-readable media of claim 14, wherein the first plurality of locations is included in a pixel within the second input frame.

18. The one or more non-transitory computer-readable media of claim 11, wherein the first input frame temporally precedes the second input frame.

19. The one or more non-transitory computer-readable media of claim 11, wherein the first output frame and the second output frame comprise at least one of edits to the first input frame and the second input frame, restoration of the first input frame and the second input frame, one or more conditions specified in the first input frame and the second input frame, or higher-resolution versions of the first input frame and the second input frame.

20. A system, comprising:
one or more memories that store instructions, and
one or more processors that are coupled to the one or more memories and, when executing the instructions, are configured to perform the steps of:
determining a first set of flow vectors between a first input frame and a second input frame;
generating, based on the first set of flow vectors and a first noise sample associated with the first input frame, a second noise sample associated with the second input frame;
converting, via execution of a diffusion model, the first input frame into a first output frame based on the first noise sample; and
converting, via execution of the diffusion model, the second input frame into a second output frame based on the second noise sample.
